(19) United States
(12) Patent Application Publication
(10) Pub. No.: US 2008/0052918 A1
(43) Pub. Date: Mar. 6, 2008

(54) FOOD PREPARATION APPARATUS AND SYSTEM

(76) Inventor: Annette Marie Sanchez, Roseville, CA (US)

Correspondence Address: LAW OFFICES OF DAVID M. LANG, 2230 MINDEN WAY, SACRAMENTO, CA, 95835, US

(21) Appl. No.: 11/844,521

(22) Filed: Aug. 24, 2007

Related U.S. Application Data
(60) Provisional application No. 60/840,856, filed on Aug. 29, 2006.

(51) Int. Cl. A47J 17/14

(52) U.S. Cl. 30/279.6

(57) ABSTRACT

A food peeler/slicing system permitting the orderly use or disposal of sliced, grated, or peeled food matter. The invention includes a handle, one or more caps, one or more blades, the blade in an embodiment being interchangeable, and one or more receptacle chambers, the chamber in an embodiment being removable. Sliced, grated, or peeled food mater is collected in the receptacle chamber for later use or disposal. The present invention discloses a variety of receptacle chamber shapes and a variety of caps which optionally may be utilized for zesting or grating food material.

### CROSS-REFERENCE TO RELATED APPLICATIONS

This application claims the benefit under 35 U.S. C. § 119(e), to U.S. Provisional Application 60/840,856, filed Aug. 29, 2006, entitled “VEGGIE PEEL WITH PEEL RECEPTACLE CHAMBER” which is incorporated by reference into this application as if fully set forth herein.

### FIELD OF THE INVENTION

The disclosed invention relates generally to food preparation devices and more specifically to fruit and vegetable peelers and slicers particularly adapted to collect peel shavings and/or sliced food.

### BACKGROUND

Conventional vegetable peelers are typically comprised of a hand-held cutting member having an apertured blade affixed to a handle. The user holds the item to be peeled in one hand and repetitively moves the blade over the surface of the subject item. As the surface of the blade makes contact with the item, the peel and/or sliced food is separated from the surface of the item, and the peel moves through the aperture and eventually severed from the item. As the process is repeated, peel and/or sliced food matter accumulates in the food preparation area. Accumulated food matter may be messy, and when deposited on the floor may be slippery, cause falls, and result in a generally hazardous work environment. This risk is compounded where the user is forced to work quickly, where peel matter is wet, where multiple individuals are involved in food preparation efforts, or where a combination of these and other factors coexist.

Several devices have been developed to facilitate peeling fruits and vegetables. For instance, U.S. Pat. No. 6,834,579 issued to Kuan, discloses, in part, a palm food processor that includes a casing which forms a receiving chamber, and a knife seat having a cutter. Kuan, while offering the advantage of an interchangeable cutting surface has drawbacks. Firstly, Kuan's chamber is designed to be held in the hand and shaped to facilitate such. However, in the slippery environment of food preparation, particularly involving fruit and vegetable peeling, a modestly large handheld chamber is relatively easy to drop when compared to a conventional peeler handle, and the larger the chamber, the more difficult the problem. This handling difficulty is compounded by the fact that fruits and vegetables are often peeled immediately after washing. A large chamber may be easily (and repetitively) dropped in such a wet environment. A smaller chamber would make handling more secure, but come at the expense of diminished peel collection capacity. Secondly, while Kuan's blade appears to be interchangeable, removal of the knife seat would appear to release, or risk releasing, substantially all the peel matter contained in the chamber into the food preparation environment. Thirdly, the user must choose one blade to place in the knife seat at a time, and therefore different cuts may not take place without first changing the blade. Fourthly, Kuan utilizes one receptacle chamber: this may cause problematic contamination where different items are peeled and certain peel material or sliced food matter itself is useful in a recipe. Fifthly, where peels or sliced food matter may be used for a recipe, there is no convenient way to dispense such matter from the apparatus. Lastly, Kuan's cutting surface is exposed and may result in user cuts.

Similarly, U.S. Pat. No. 5,251,377 to Ho discloses, in part, a oval shaped housing with a concavely curved surface containing a blade, with a curved cutting edge, secured inside the housing and projecting through a slot, such that the cutting edge of the blade generally conforms to the concavely curved surface. Like Kuan's apparatus, Ho's design is relatively cumbersome to hold and may be prone to dropping. Further, while in some instances Ho's concavely curved surface and curved blade may accommodate some slender, uniformly shaped vegetables well, any irregularly shaped, uneven, or small fruits or vegetables may not adequately fit into the fixed concavity making peeling of these items difficult or impossible. U.S. Pat. No. 4,369,574 to Hsien-Sen discloses, in part, two blades inset into a columnar box with a handle portion, a scrape plate disposed inside the columnar box connected to a top lid by a linkage bar. Hsien-Sen's apparatus does not permit changing of the cutting surface, chamber, or handle. Further, the scrape plate mechanism, designed to clear peel matter, may be quite difficult to clean, cumbersome to use, unnecessary, add to product weight, and require additional manufacturing expenses to produce.

What is needed is a variable-use apparatus which has a chamber capable of receiving a variety of changeable cutting surfaces coupled to a suitably sized and appointed handle to facilitate repetitive use. Additionally, what is needed is an apparatus permitting the optional use of multiple peel receptacle chambers. What is further needed is a peeling and/or slicing device permitting the user the option of changeing the blade quickly, readily, and safely. What is further needed is an apparatus which will protect the user from blade injury when the device is not in use. What is further needed is an apparatus permitting peel and/or sliced food storage such that the food matter is ready for use when required by a recipe and a convenient apparatus to dispense peels therefrom. What is additionally needed is a peeler with sufficient capacity to maintain a productive workflow allowing the user to defer peel disposal to a safe and convenient time and place. What is further needed is a peeling and/or slicing apparatus with an optimal receptacle chamber shape to facilitate stability on the countertop while maximizing receptacle chamber storage capacity. What is further needed is a peeler that contributes to the overall safety and cleanliness of the food preparation area by eliminating the fall hazard created by stray peels and sliced food matter and eliminating the need to handle and/or peel food directly over an unclean garbage can.

### SUMMARY

Certain aspects of the present invention, disclosed more fully herein, include a fruit and vegetable peeling system which has a plurality of interchangeable blades which may be changed while retaining peels in the receptacle chamber. Additionally, aspects of the present invention include a series of interchangeable receptacle chambers, detachable from the apparatus handle, permitting peel matter from different fruits or vegetables to be separated. Additionally a variety of interchangeable caps which permit zesting, grating, and the like, such that the subject food is deposited directly into a bladed or bladeless receptacle chamber. Further, aspects of the present invention include a two-part receptacle chamber, a portion of which may be inverted and used as a dispensing tray. An additional aspect of the present invention includes an embodiment optimally shaped receptacle chamber that maximizes stability on the countertop surface and will affording large receptacle chamber capacity.

Additionally, the subject peeler/slicer is lightweight, and easy to maneuver during the peeling/slicing process. Furthermore, the user is able to keep the workstation clean, tidy, and free of unwanted peels and/or sliced food matter. The present invention also reduces clean-up time during food preparation in that a preparer is not required to lay out paper to collect peels, pull out the trash pail, or work over the kitchen sink. The user is not forced to handle dirty trash pails during food preparation, helping the workstation remain free of unwanted bacteria. The invention also minimizes the risk of a hazardous food preparation environment where slippery stray peelings fall to the floor and present a fall risk. The subject peeler also eliminates the possibility that the user's kitchen sink will become clogged with food peelings that a garbage disposal unit cannot handle and eliminate the possibility that peels will damage a garbage disposal requiring costly repairs or replacement. Furthermore, peeling efficiency, comfort, and efficiency is maximized through use of an easily gripped handle combined with a large capacity container to collect peel matter and/or sliced food for disposal or use at an opportune time.

### BRIEF DESCRIPTION OF THE DRAWINGS

FIG. 1 is a perspective view of the rectangularly-shaped receptacle chamber embodiment peeler.

FIG. 2 is a partially exploded view of the rectangularly-shaped receptacle chamber embodiment peeler depicting an optional blade cover.

FIG. 3 is a front elevation view of the cylindrically-shaped receptacle chamber embodiment peeler depicting an optional blade cover in place.

FIG. 4 is a front elevation view of the cylindrically-shaped receptacle chamber embodiment peeler depicting the exposed blades.

FIG. 5 is a side elevation view of the cylindrically-shaped receptacle chamber embodiment depicting the blade and optional blade cover.

FIG. 6 is a side elevation view of the cylindrically-shaped receptacle chamber embodiment depicting the blade and optional blade cover.

FIG. 7 is a bottom view of the rectangularly-shaped receptacle chamber embodiment.

FIG. 8 is a front view of the outside of the optional blade cover.

FIG. 9 is a back view of the inside aspect of the optional blade cover.

FIG. 10 is a side view of the optional blade cover.

FIG. 11 is a top view of the optional blade cover.

FIG. 12 is a perspective view of the cylindrically-shaped receptacle chamber embodiment peeler depicting the optional arcuate blade cover.

FIG. 13 is a perspective view of the cylindrically-shaped receptacle chamber embodiment depicting the optional arcuate blade cover and the cap removed.

FIG. 14 is a front view of the cylindrically-shaped receptacle chamber embodiment depicting the optional arcuate blade cover in place and the cap removed.

FIG. 15 is a front view of the cylindrically-shaped receptacle chamber embodiment with the cap removed.

FIG. 16 is a side view of the cylindrically-shaped receptacle chamber embodiment depicting the optional arcuate blade cover in place.

FIG. 17 is a side view of the cylindrically-shaped receptacle chamber embodiment depicting the optional arcuate blade cover in place.

FIG. 18 is a bottom view of the cylindrically-shaped receptacle chamber embodiment.

FIG. 19 is a top view of the cylindrically-shaped receptacle chamber embodiment depicting the blades and the optional arcuate blade cover in place.

FIG. 20 is a top view of the arcuate blade cover.

FIG. 21 is a bottom view of the arcuate blade cover.

FIG. 22 is a side view of the arcuate blade cover.

FIG. 23 is a top view of the arcuate blade cover.

FIG. 24 is a perspective view of the cylindrically-shaped receptacle chamber embodiment depicting the optional interchangeable blade system illustrating a blade cartridge in place.

FIG. 25 is a partially exploded perspective view of the cylindrically-shaped receptacle chamber embodiment with an embodiment threadable cap illustrating the optional interchangeable blade system with the blade cartridge in the removed position.

FIG. 26 is a partially exploded front view of the cylindrically-shaped receptacle chamber embodiment with an embodiment threadable cap.

FIG. 27 is a cross-sectional view taken through 27-27.

FIG. 28 is a partially exploded front view of the cylindrically-shaped receptacle chamber embodiment with an embodiment threadable cap illustrating the optional interchangeable blade system with the blade cartridge in place.

FIG. 29 is a cross-sectional view taken through 29-29.

FIG. 30 is a front view of an embodiment peeler blade.

FIG. 31 is a magnified cross-sectional view of the peeler blade taken through line 31-31.

FIG. 32 is a front view of an embodiment slicer blade.

FIG. 33 is a magnified cross-sectional view of the slicer blade taken through line 33-33.

FIG. 34 is a front view of an embodiment crinkle-cutter blade.

FIG. 35 is a magnified cross-sectional view of the crinkle-cutter blade taken through line 35-35.

FIG. 36 is a cross-sectional side view of a blade cartridge depicting the locking mechanism in the locked position.

FIG. 37 is a perspective view of the cylindrically-shaped receptacle chamber embodiment with an embodiment grater cap in place.

FIG. 38 is a partially exploded perspective view of the cylindrically-shaped receptacle chamber embodiment with an embodiment threadable grater cap.

FIG. 39 is a perspective view of the cylindrically-shaped receptacle chamber embodiment with an embodiment zester cap in place.

FIG. 40 is a top view of the embodiment grater cap.

FIG. 41 is a top view of the embodiment zester cap.

FIG. 42 is a perspective view of an embodiment D-profile receptacle chamber embodiment depicting the cap removed.

FIG. 43 is a perspective view of an embodiment two-part, D-profile receptacle chamber.

FIG. 44 is a perspective view of an embodiment two-part, D-profile receptacle chamber depicting use as a dispensing tray.

### DETAILED DESCRIPTION OF CERTAIN ASPECTS OF THE PREFERRED AND ALTERNATIVE EMBODIMENTS

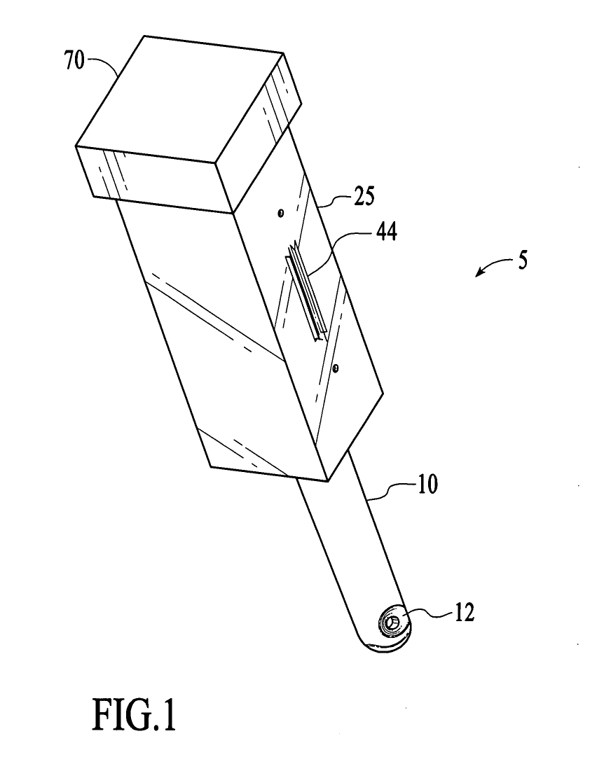

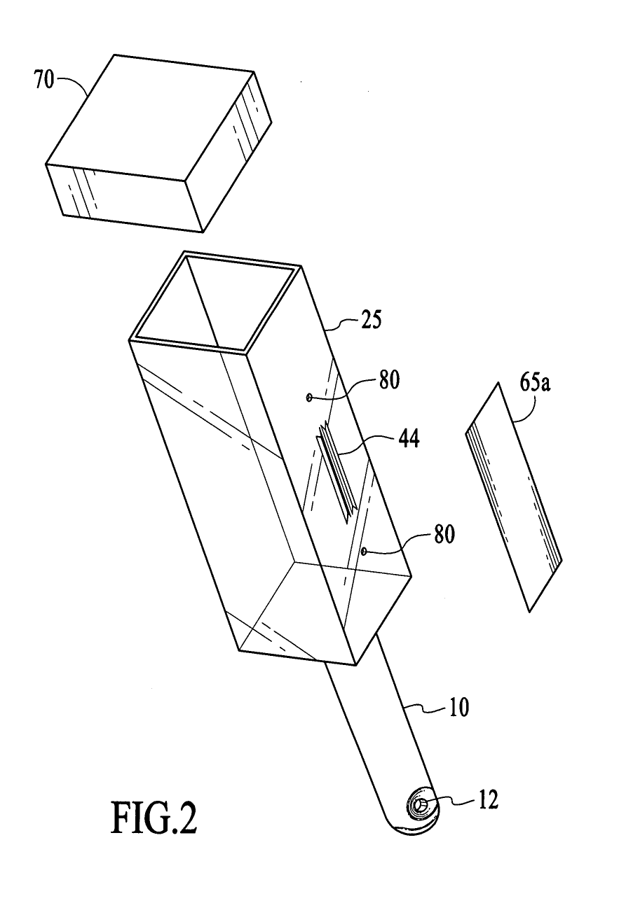

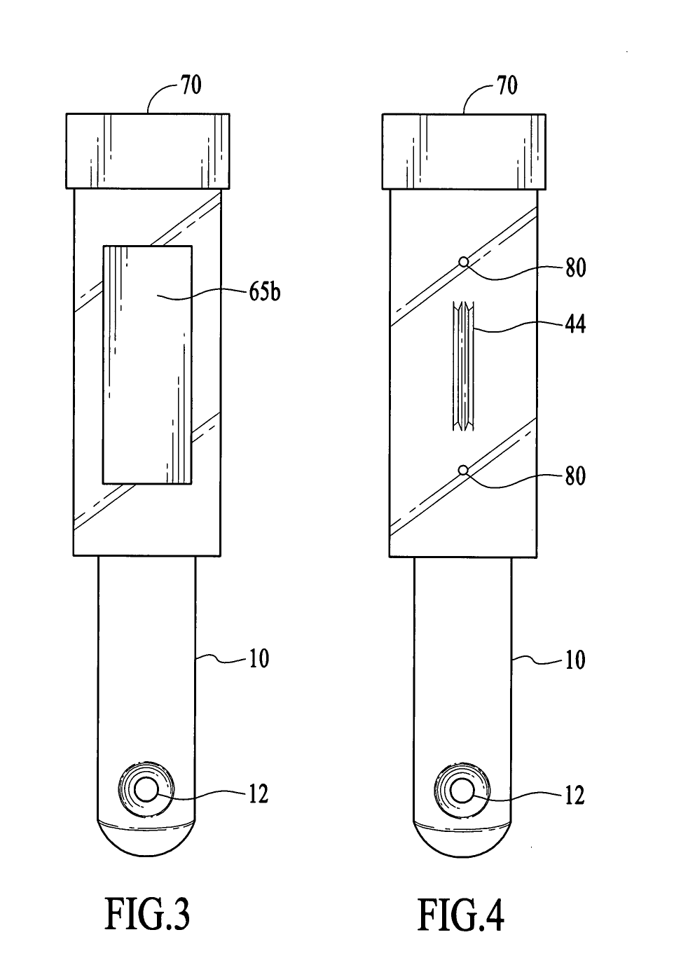

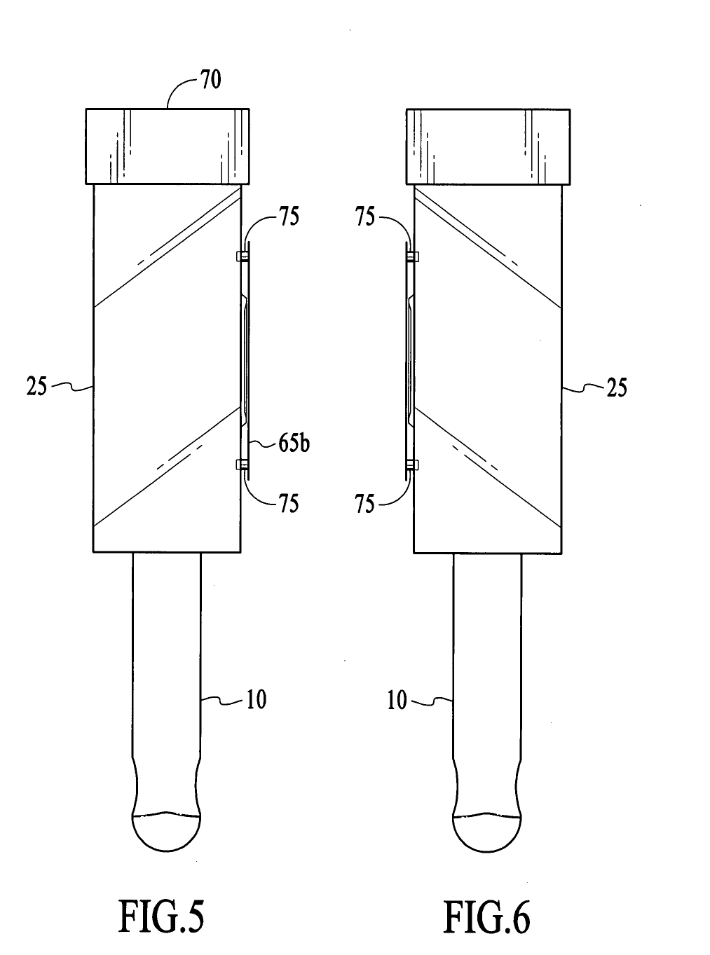

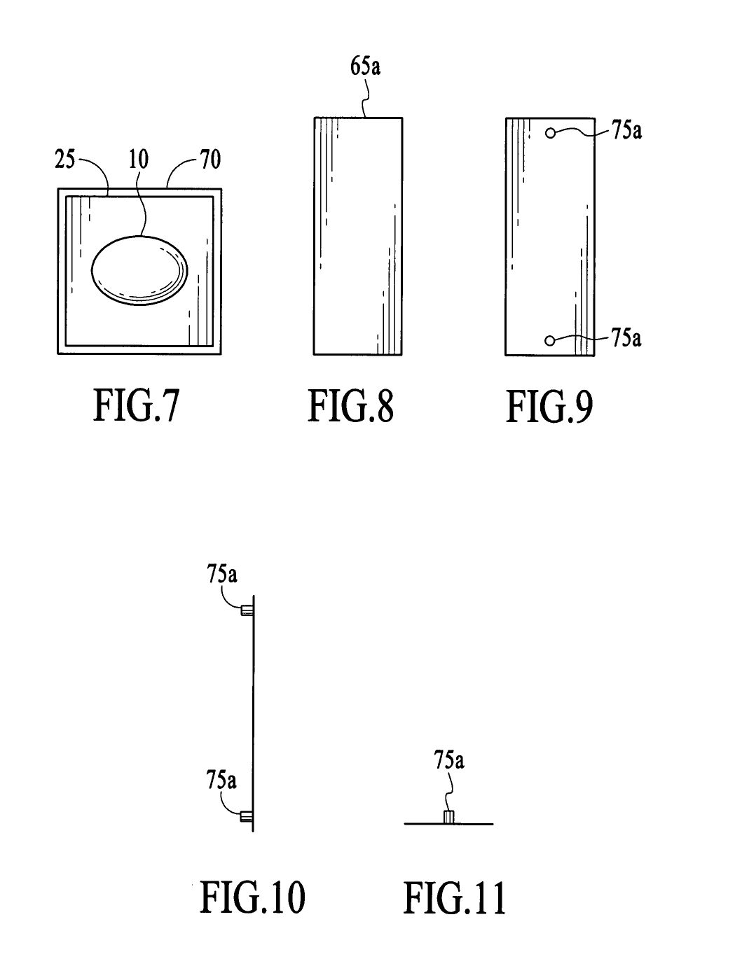

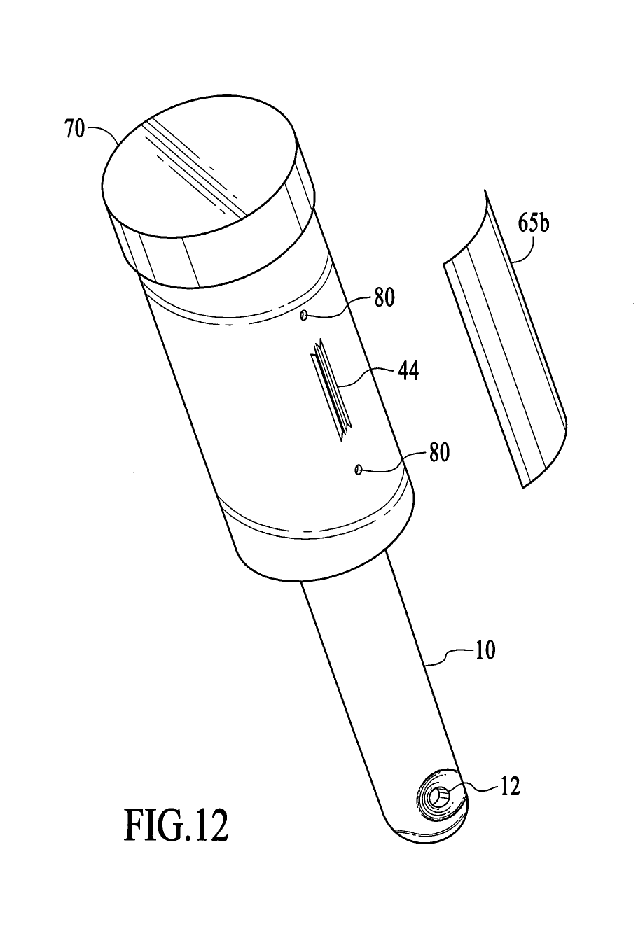

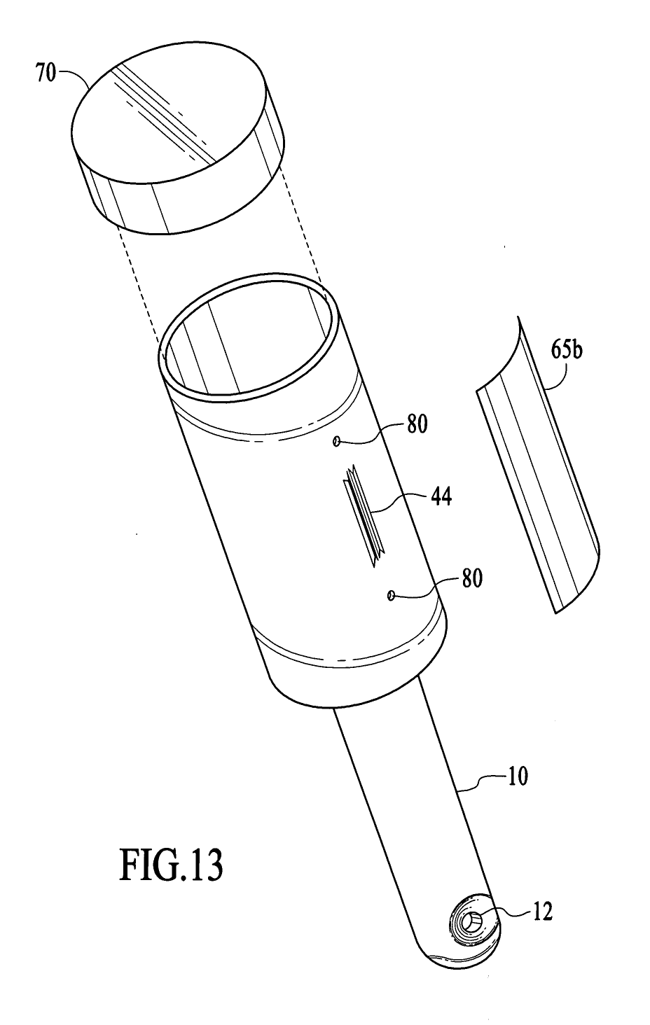

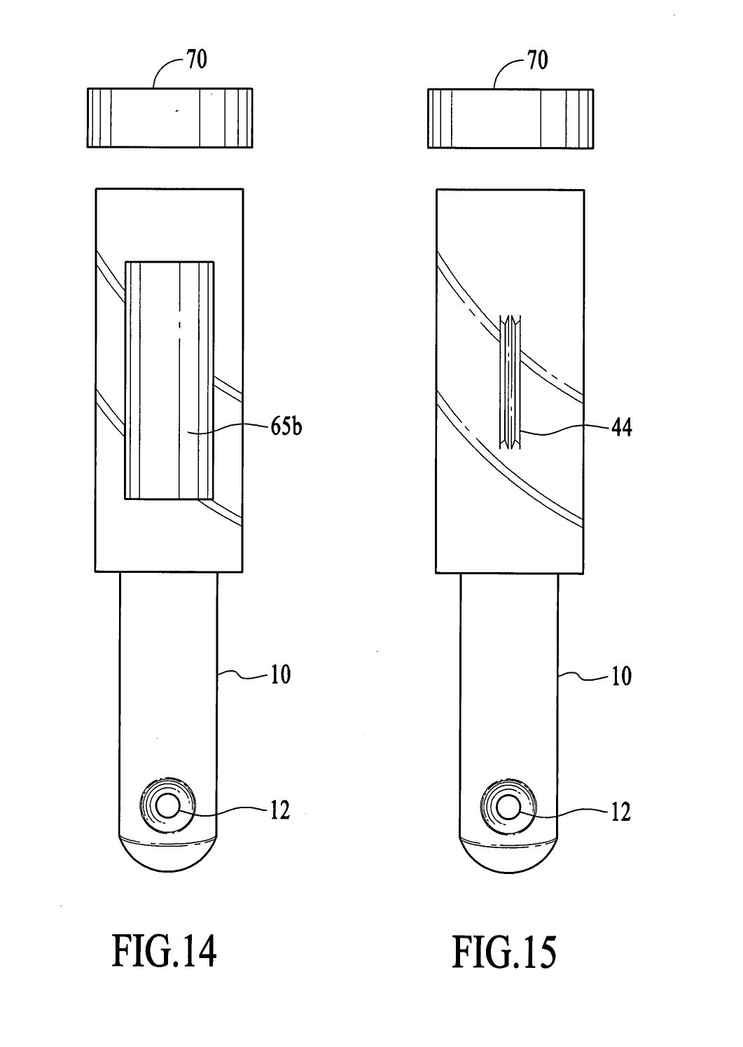

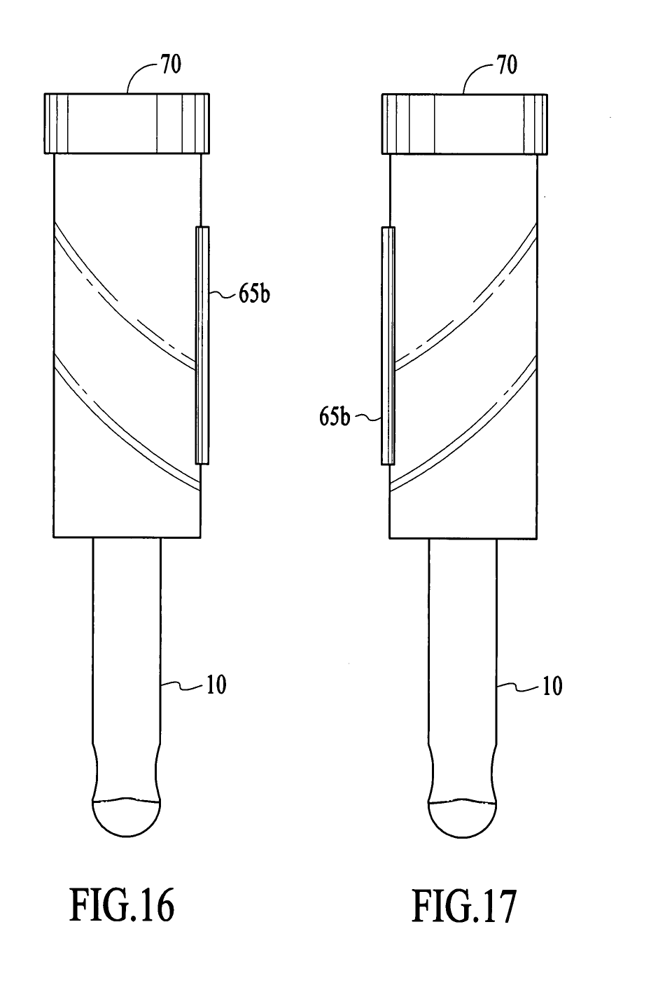

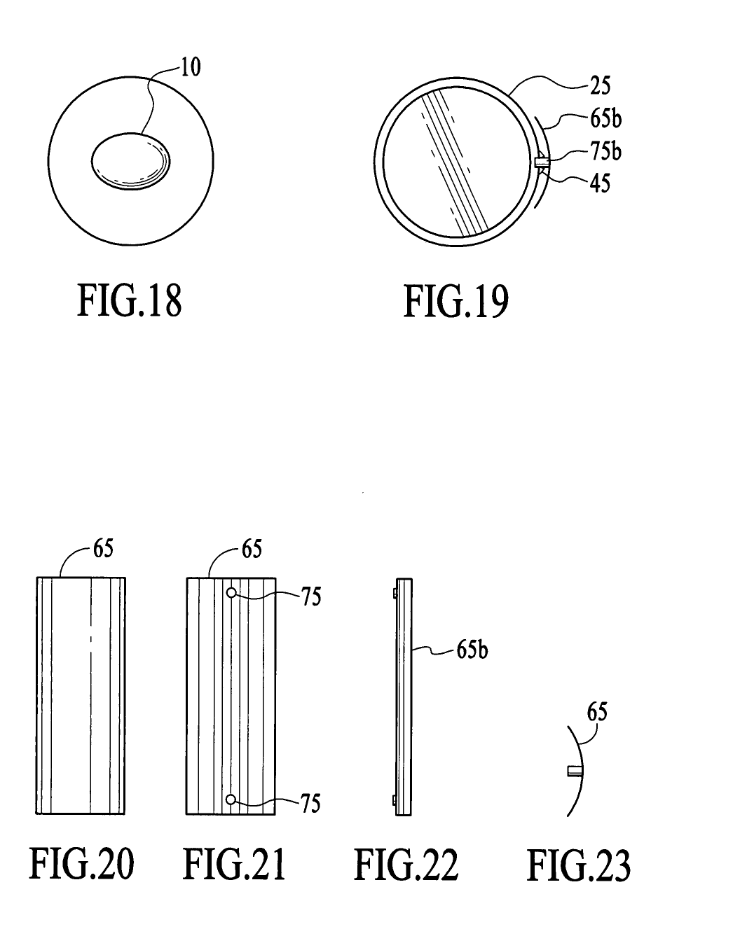

Turning now to FIG. 1, the apparatus generally 5 is comprised of a handle 10, which in a preferred embodiment is cushioned with foam, soft rubber, or another similar material providing comfort to the user's hand and more reliable slip-resistant tool handling. Handle 10, having a hanging eyelet 12, is securably affixed to the first end of receptacle chamber 25, through a bolt screw, adhesive, or other reliable affixing means. In one embodiment, chamber 25 has blade 44 affixed. In one non-limiting example embodiment, blade 44 is comprised of a pair of cutting elements spaced to provide a V-shaped groove with a gap of approximately 1/32″ to facilitate bidirectional cutting and entry of peel matter into receptacle chamber 25. On the second end of chamber 25, cap 70, comprised of rubber or plastic, may be push-fit over the second end of chamber 25 such that it is in snug frictional engagement with the second end of chamber 25 thereby relatively sealing the same. As illustrated by FIG. 2, an optional flat blade cover 65a may be disposed over blades 44 and secured through a pair of tabs 75 (illustrated by FIGS. 9, 10, and 11) located near either end of cover 65. Tabs 75 reversibly snap-fit into frictional or detent engagement within blade cover apertures 80 located on the surface of chamber 25 beyond both ends of blades 44 whereby blades 44 are underneath cover 65. To remove cover 65, the user pulls cover 65 away from the surface of chamber 25, frictional or detent engagement between tabs 75 and apertures 80 is overcome, and cover 65 is removed. Receptacle chamber 25 may be comprised of transparent or opaque plastic and may be rectangular, cylindrical or D-profile. As illustrated by FIGS. 8-11, in the rectangular embodiment, blade cover 65a is planar and, as illustrated b FIGS. 20-23, in the cylindrical embodiment blade cover 65b is arcuately shaped to correspond the surface of the receptacle chamber 25 and rest flushly thereagainst.

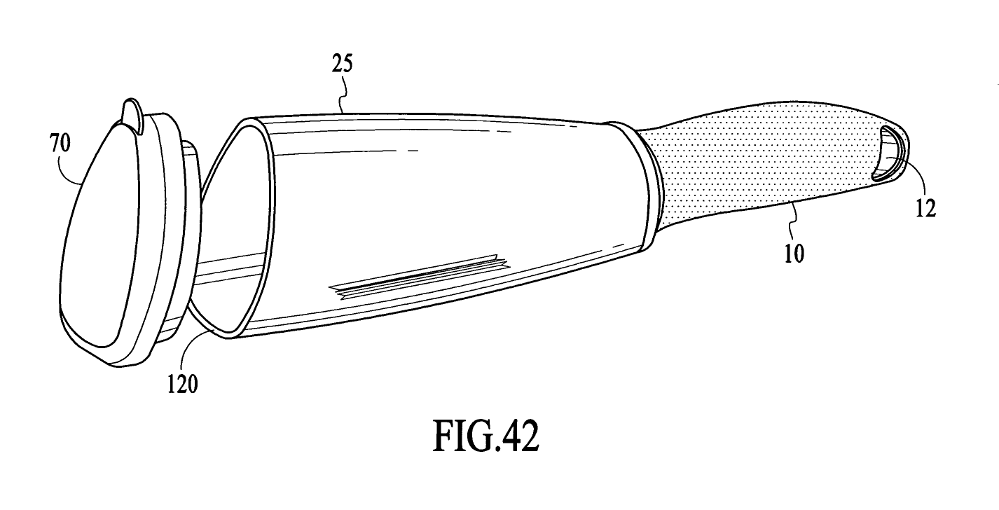

In an alternative embodiment, illustrated by FIG. 42, receptacle chamber 25 is a tapered D-profile shaped such that it may be easily rested on a flat surface. The dependent surface 120 is wider than the apex surface, and facilitates stability when rested on flat surface.

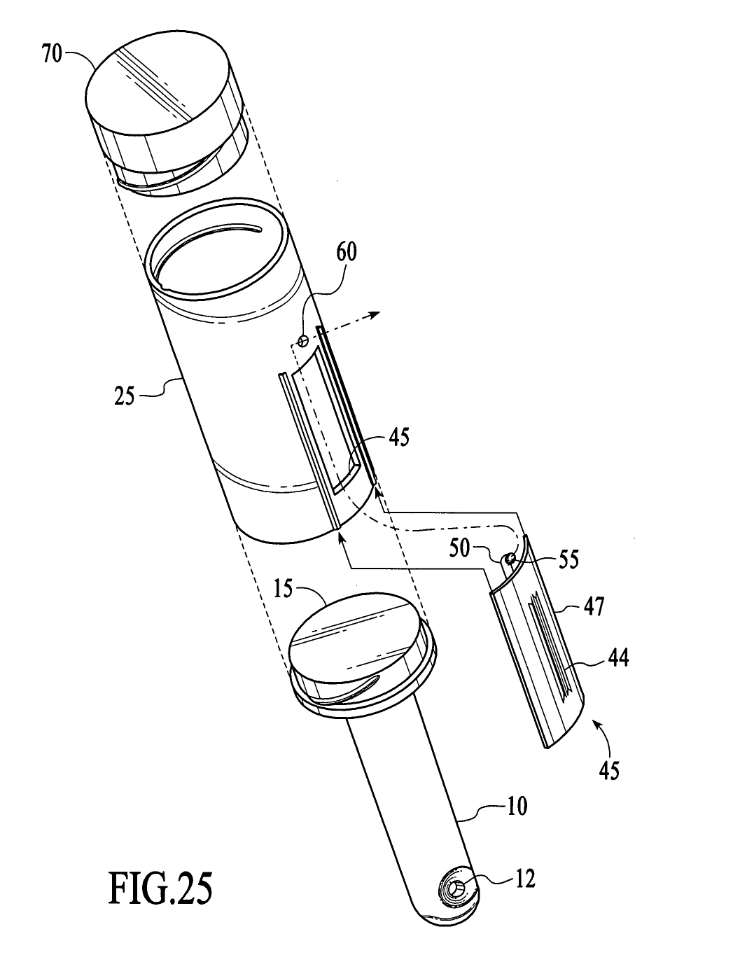

In one embodiment, the present invention utilizes detachable/interchangeable receptacle chambers, as seen on FIG. 25. The first end of chamber 25 is coupled to disc 15, by threadable engagement, so that chamber 25 may be disengaged from the threadably coupled disc 15/handle 10 element. In use, to change receptacle chambers, the user grips the existing chamber 25 and holds handle 10 firmly and rotates chamber 45 counterclockwise relative to the chamber-contact side of disc 15 thereby threadably disengaging chamber 25 from disc 15. By the reverse process, the replacement chamber is rotated clockwise and threadably engages disc 15. It should be noted that a variety of coupling mechanisms are known in the prior art to reversibly couple a handle to the chamber, although a threadable mechanism is disclosed, the present invention is not limited to this type of coupling and the present invention may be practiced utilizing a snap-fit or any variety of methods to couple the handle to the chamber such that one chamber may be detached and another attached.

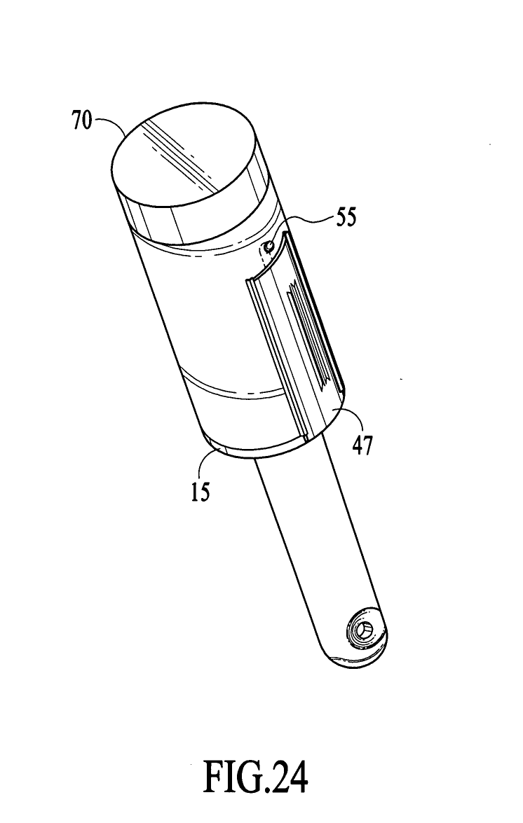

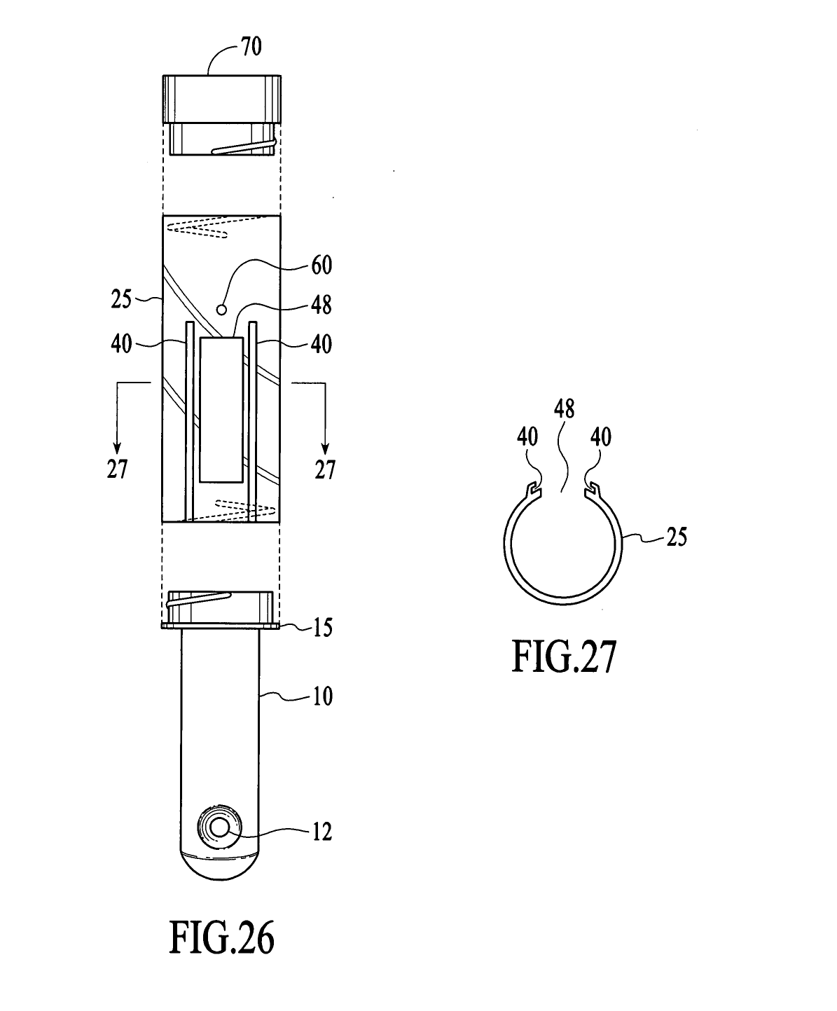

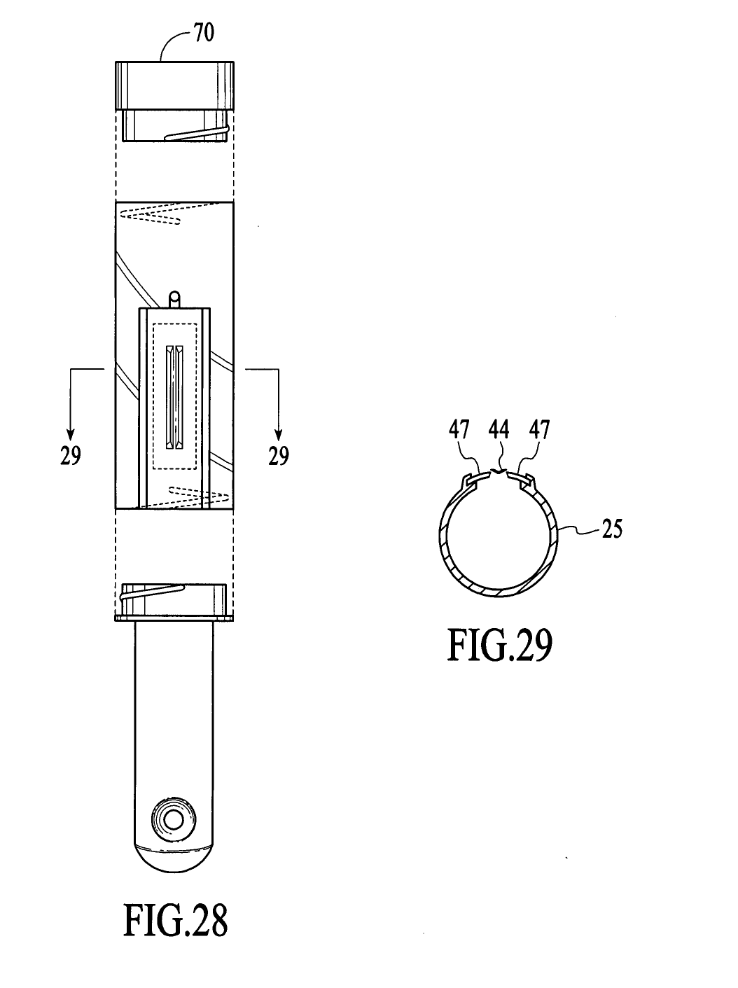

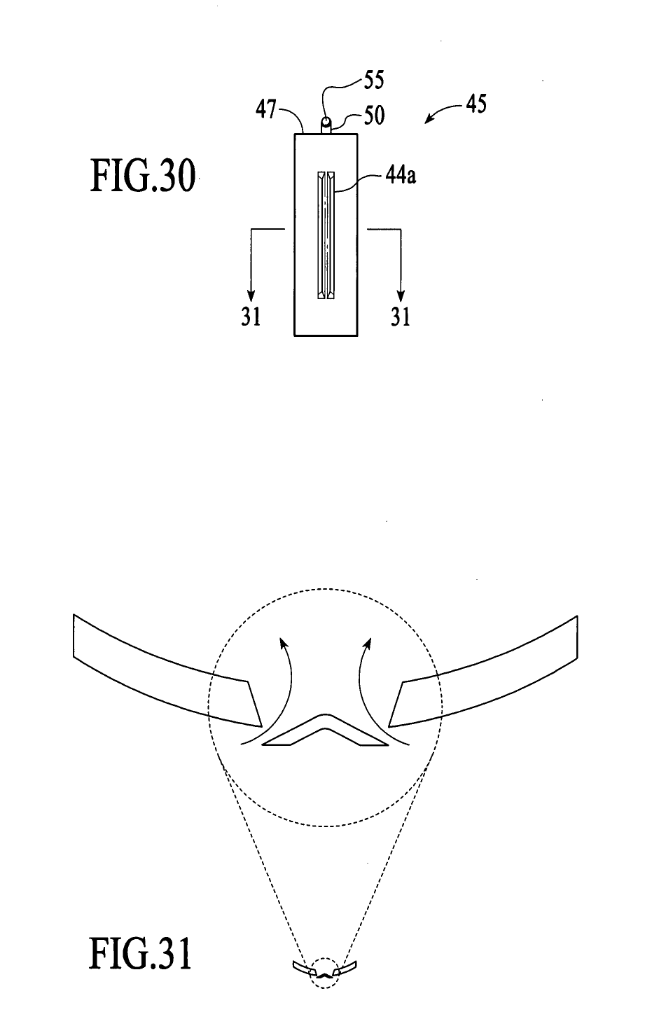

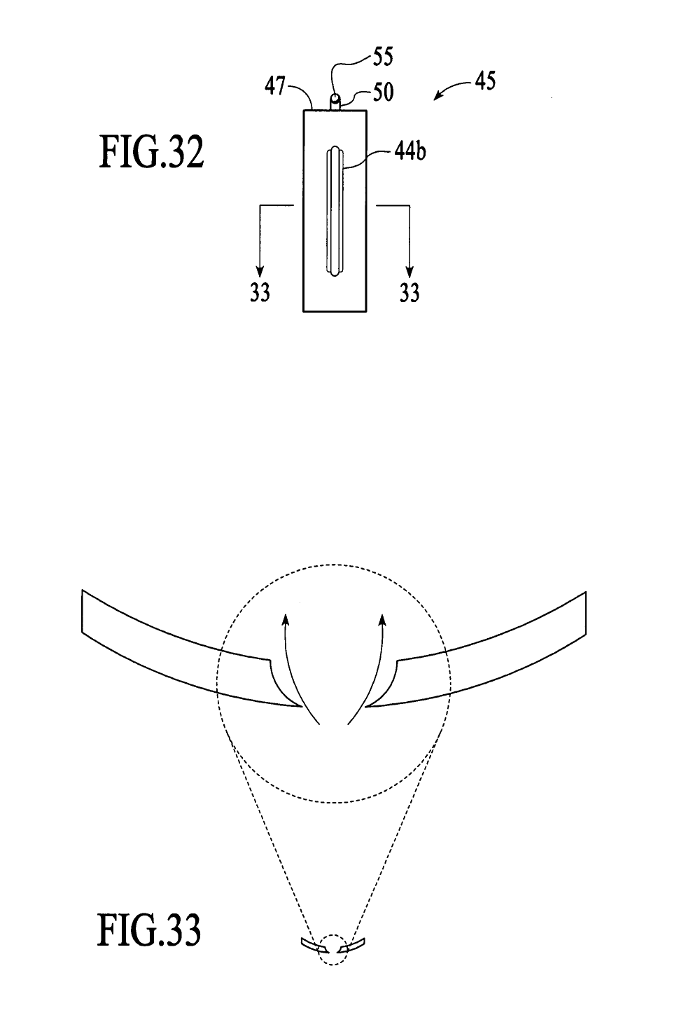

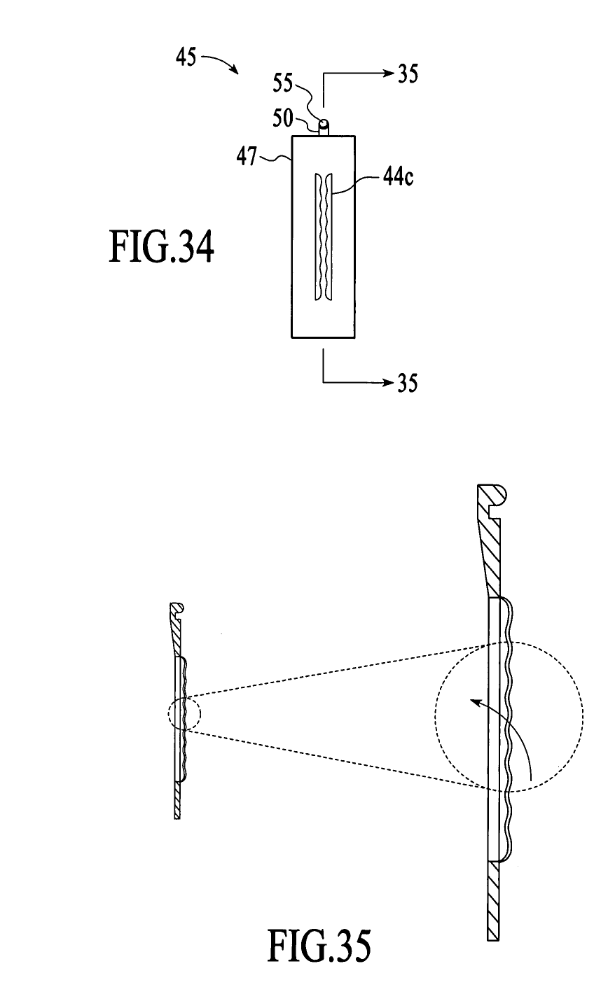

In one embodiment, as illustrated by FIG. 25 the present invention includes interchangeable blade cartridges, where chamber 25 is adapted to receive different blades such as, for example, a slicing blade, a peeler blade, or a crinkle-cut blade. Turning to FIG. 26, a pair of parallel blade grooves 40 is formed just outside chamber 25 over opening 48 in chamber 25 to permit entry of peels and/or sliced food matter into chamber 25. FIG. 27, taken through line 27-27 illustrates a cross-section of grooves 40 above opening 48. Illustrated on FIG. 25, cartridge 45 is comprised of a plastic blade casing 47 and blade 44 which is embedded within casing 47. The outer aspect of casing 47 slidably engages grooves 40, whereby cartridge is insertable and removable along grooves 40 on chamber 25. FIG. 24 illustrates a cartridge 45 inserted such that the proximalmost end of said cartridge (relative to said handle) lies just outside disc 15. This permits removal/insertion of cartridge 45 when the receptacle chamber 25 is coupled to the disc 15/handle 10. As cartridge 45 is removed, any one of a plurality of blade cartridges may be utilized to obtain different cutting results. FIGS. 30-35 illustrate non-limiting examples of such blades include a slicing blade 44a, a peeler blade 44b, and a crinkle-cut blade 44c.

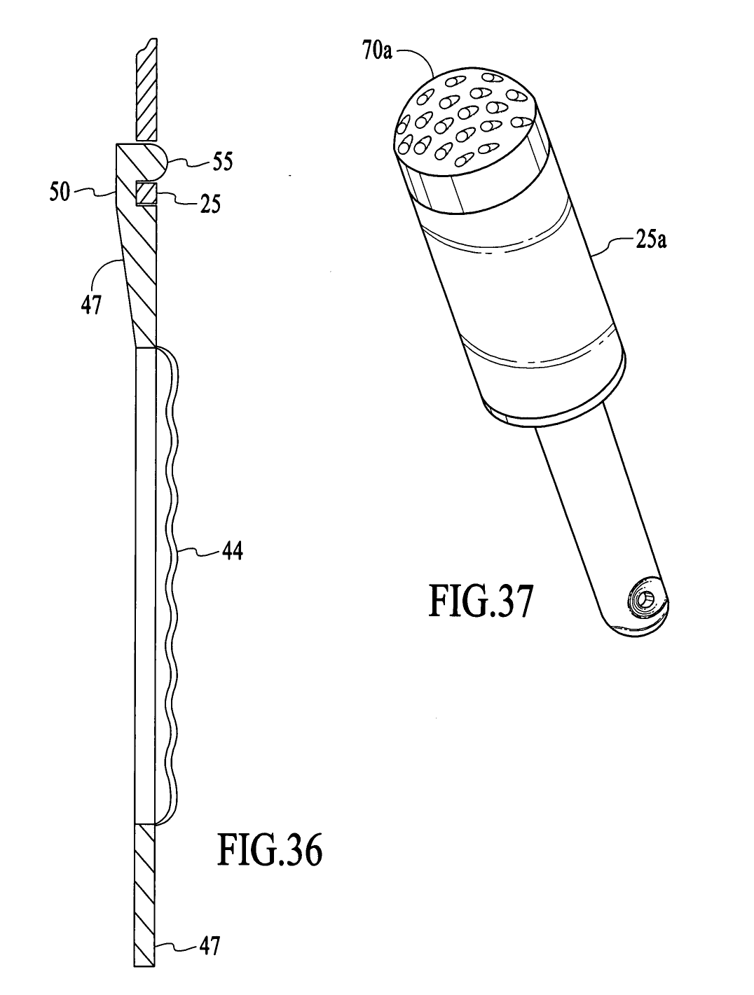

Cartridge 45 may be locked into place on chamber 25. As a non-limiting example locking mechanism, illustrated by FIG. 36, casing 47 terminates in projection 50, integrally formed with casing 47, and extending outwardly from the blade cartridge 45, and is resiliently movable relative to the remainder of blade casing 47. Projection 50 angles outwardly relative to the centermost aspect of chamber 25 such that it is perpendicularly disposed to the long axis of the apparatus and blade casing 47. Projection 50 terminates in release button 55 which reversibly engages aperture 60 disposed on chamber 25. In operation, blade cartridge 45 is released through manual depression of button 55 which displaces projection downwardly and disengages projection 50 from aperture 60 and permits cartridge 45 to be slidably removed from chamber 25 along grooves 40. New cartridge 45 is slidably inserted and advanced away from the handle, along grooves 40, toward cap 70. When the distalmost end of button 55 makes contact with chamber 25, projection 50 is deflected inwardly toward the center of chamber 25 and placed under resilient tension until cartridge is advanced sufficiently to discharge resilient tension in projection 50 by permitting button 55 to emerge through aperture 60, whereby cartridge 45 is locked into place, the locked stated illustrated by FIG. 36. It should be noted that a variety of securing mechanisms are known in the prior art to reversibly engage and disengage blade 44 and chamber 25, although slidable mechanism with a locking feature is disclosed, the present invention is not limited to this type of coupling, and the present invention may be practiced utilizing any mechanism to couple and secure a given blade to chamber 25.

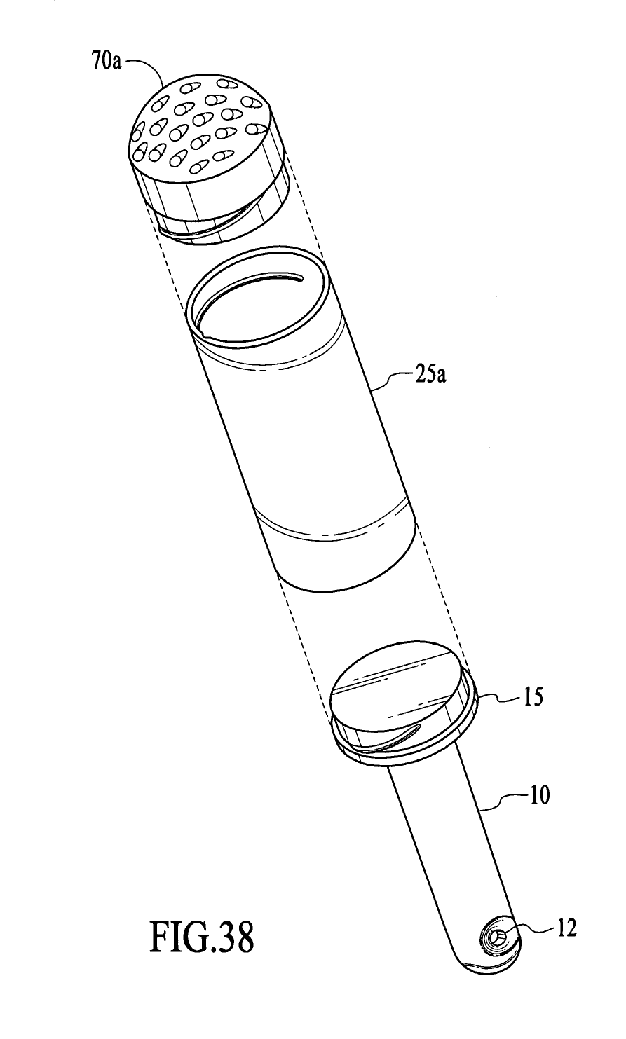

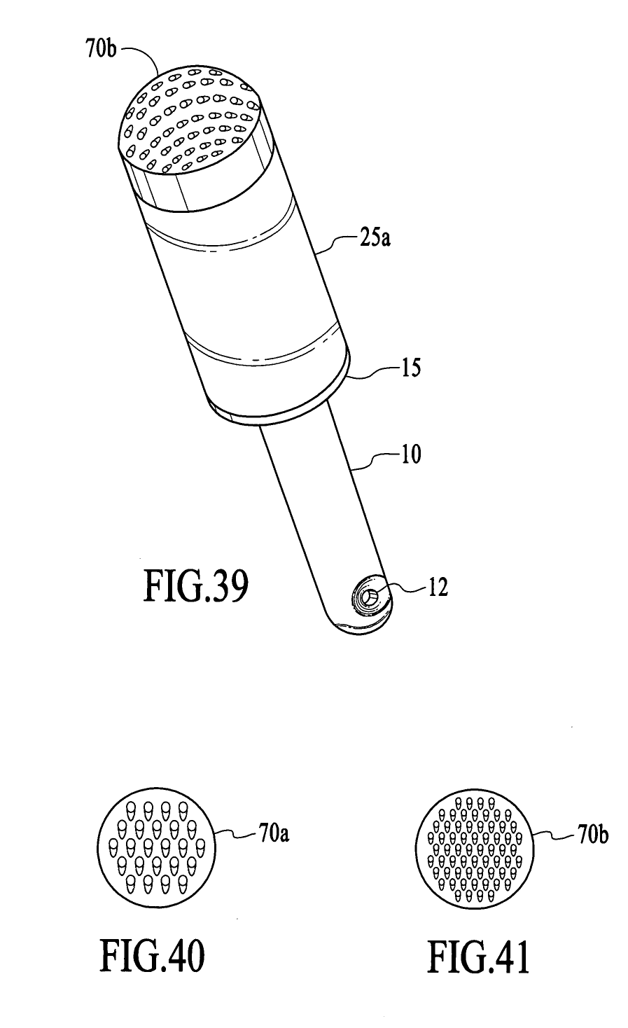

Cap 70 is reversibly fitted onto the second end of chamber 25, through any means including, as nonlimiting examples: threadably secured, snap fit, or push-fit and secured through frictional engagement. Cap 70 may be formed to include a cutting surface affixed, integrally disposed within, or adjacent to the cap, and nonlimiting example cutting caps include a grating cap 70a (FIGS. 37, 38, and 40) and a zesting cap 70b (FIGS. 39 and 41). FIGS. 39 and 42 illustrate a bladeless receptacle chamber embodiment. As illustrated by FIG. 39, chamber 25a may be secured to disc 15 and used to collect material generated from a cutting cap such as the embodiment grater 70a or zester 70b caps. A cutting cap may be also used with a fixed or interchangeably bladed receptacle chamber 25 where a combination effect is desired. In an alternative embodiment, grating and zesting blades may be utilized in the interchangeable blade system and incorporated into blade cartridge 45.

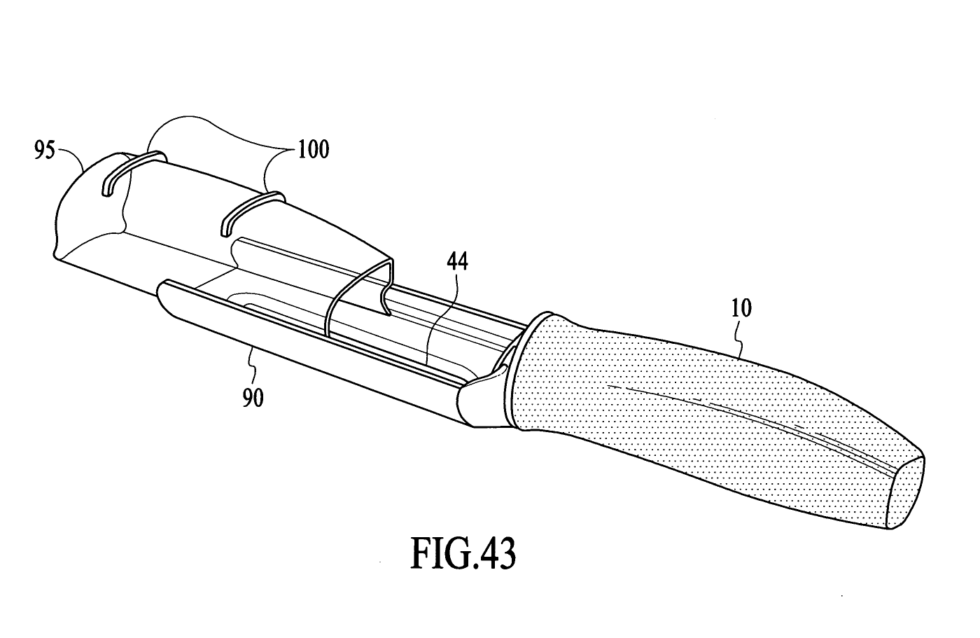

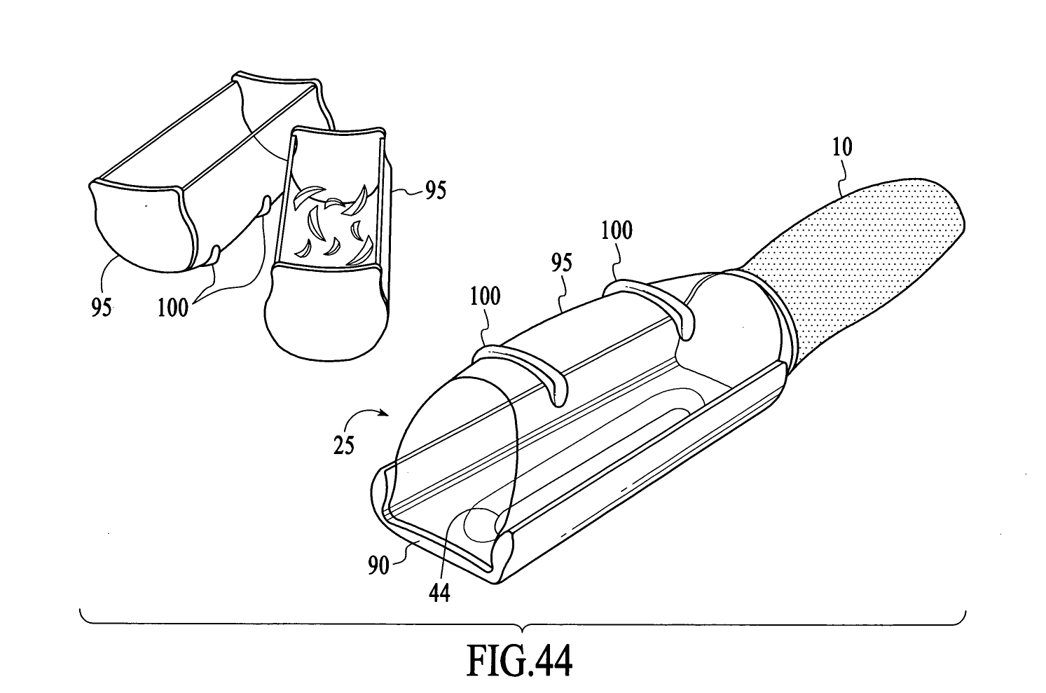

In an alternative embodiment, illustrated by FIGS. 43 and 44, the receptacle chamber 25 is D-profile a multi-part design comprised of two slidably engaging members. The first member 90 is flat on one surface and facilitates resting the product securely on a countertop or the like. Second member 95 is capable of being slidably disposed within first member and advanced toward the handle until maximally engaged whereupon first member 90 and second member 95 form a relatively sealed chamber 25. In one embodiment, second member 95 is locked firmly in place within first member 90 through one or more projections on the distalmost aspect of first member 90. Blade 44 is affixed, set on, or set within second member 95, and a different blade style may be incorporated within a different, interchangeable second member 95. The first member may be coupled to handle 10 as previously described, or may be integrally formed therewith. Second member 95 has ridges 100 disposed perpendicular to the long axis of the apparatus such that second member 95, as illustrated by FIG. 44, may be slidably uncoupled from first member 90, inverted and rested on ridges 100, whereby useable peel or sliced food material may be dispensed directly from said inverted second member 95. An optional cover (not shown) may be utilized to cover second member 95, thereby keeping peeled and/or sliced food fresh and free of contamination. The D-profile shape provides stability where the relatively flat portion of first member 90 is wide and securely positioned on a flat surface, countertop, or the like. Further, in one embodiment, second member 95 narrowingly tapers toward said handle such that it is widest at the distalmost end and narrowest at the proximalmost end nearest handle 10. This tapering further facilitates rapid removal of peel and/or sliced food wherein a relatively large amount of the contents are deposited in the distalmost end of receptacle chamber 25. To perform a rapid clearing of the chamber, the user snaps the apparatus in the wrist to collect a majority of the peels/sliced food in the distalmost aspect of chamber 25. Then, the user may modestly open chamber 25 by sliding 95 away from handle 10, and quickly clear the majority of the retained contents.

Regarding method of use generally, fruit or vegetable item to be peeled or sliced is held in the user's first hand and the apparatus held in the opposite hand. The peeler is advanced over the surface of the fruit or vegetable in a typical manner. The peels and/or sliced food is cut, severed, and collected in receptacle chamber 25. Regarding the interchangeable blade, when the user wishes a different cut, the blade cartridge 45 is changed by depressing button 55 thereby disengaging the projection 50 from the recess 60 in chamber 25 and sliding blade cartridge 45 from grooves 40 toward handle 10. New blade cartridge 45 is inserted into grooves 40 and advanced away from handle 10, along the long axis of chamber 25, until projection 50 and button 55 snap into recess 60 whereby new blade cartridge 45 is locked into place.

In the various embodiment detailed above, where chamber 25 is comprised of transparent plastic indicia may be etched, painted, or otherwise disposed on the plastic. It should be noted that the interchangeable blade system, and multiple/detachable receptacle chamber system may be used with the rectangularly-shaped embodiment as well.

Although the present invention has been described with reference to the preferred embodiments, it should be understood that various modifications and variations can be easily made by those skilled in the art without departing from the spirit of the invention. Accordingly, the foregoing disclosure should be interpreted as illustrative only and is not to be interpreted in a limiting sense. It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. A food preparation system comprising:
a handle;
a detachable receptacle chamber having a first end and a second end, said first end reversibly coupled to said handle;
a blade affixed to said receptacle chamber;
a cap detachably coupled to said chamber's second end;
whereby a relatively sealed chamber is formed when said cap is coupled to said second end, and whereby said detachable receptacle chamber may be removed and replaced with an alternative receptacle chamber.

2. The food preparation system of claim 1, wherein said receptacle chamber is rectangular in shape.

3. The food preparation system of claim 1, wherein said receptacle chamber is cylindrical in shape.

4. The food preparation system of claim 1, wherein said receptacle chamber is substantially D-shaped.

5. The food preparation system of claim 4, wherein said receptacle chamber narrowingly tapers toward said handle.

6. The food preparation system of claim 1, wherein said removable cap has a cutting surface affixed to said cap.

7. The food preparation system of claim 6, wherein said cutting surface is a zester.

8. The food preparation system of claim 6, wherein said cutting surface is a grater.

9. A food preparation system comprising:
a handle;
a detachable receptacle chamber having a first end and a second end, said first end reversibly coupled to said handle, wherein said chamber is shaped to define an opening having a pair of parallel blade grooves on either side of said opening;
an interchangeable blade cartridge having a blade casing and blade embedded within the casing, wherein the outer aspect of casing slidably engages said blade grooves, whereby cartridge is insertable and removable along grooves on said chamber;
a cap detachably coupled to said chamber's second end;
whereby a relatively sealed chamber is formed when said cap is coupled to said second end, and whereby said detachable receptacle chamber may be removed and replaced with an alternative receptacle chamber.

10. The food preparation system of claim 9, further comprising: a locking means to secure said cartridge on said chamber.

11. A food preparation apparatus comprising:
a handle;
a substantially D-shaped receptacle chamber having a first member and second member said first member coupled to said handle and said second member slidingly engagable with said first member;
a blade affixed to said second member;
whereby a relatively sealed chamber is formed with first and second members are fully engaged.

12. The food preparation apparatus of claim 11, wherein said receptacle chamber narrowingly tapers toward said handle.

13. A food peeling and slicing apparatus comprising:
a handle, said handle having a cushioning means;
a removable receptacle chamber having a first member and second member said first member coupled to said handle and said second member slidingly engagable with said first member, wherein said first member and second member form a relatively sealed container when fully engaged, wherein said second member is slidingly removed from said first member, whereby said second member, when inverted and placed on a level surface, may be used as a serving tray for peeled, sliced, or cut product contained within receptacle chamber.

14. The food peeling and slicing apparatus, of claim 13, wherein said second member is shaped to define ridges disposed perpendicular to the long axis of the apparatus wherein said second member, may be slidably uncoupled from said first member, inverted and rested on ridges, whereby useable peel or sliced food material may be dispensed directly from said inverted second member.
